(19) United States
(12) Patent Application Publication
(10) Pub. No.: US 2011/0151853 A1
(43) Pub. Date: Jun. 23, 2011

(54) COMMUNICATION DEVICE FOR LIMITING DATA TRANSITION AND COMMUNICATION METHOD THEREOF

(75) Inventor: GUI-PENG WANG, Shenzhen City (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/915,061

(22) Filed: Oct. 29, 2010

(30) Foreign Application Priority Data
Dec. 17, 2009 (CN) 200910311732.1

(51) Int. Cl. H04M 3/00

(52) U.S. Cl. 455/418

(57) ABSTRACT

A communication device includes a switch, a sensor, a controller, an indication module and a wireless communication module. When the communication device is in a safety mode, the sensor detects a velocity of the communication device when an incoming call of the communication device is received, the wireless communication module communicates with at least one terminal by answering the incoming call. When the velocity exceeds a preset threshold value after a buffer time, the controller terminates the communication.

### BACKGROUND

1. Technical Field

The present disclosure relates to a communication device, and more particularly to a communication device cable of limiting data transition in a safe drive mode.

2. Description of Related Art

An increasing variety of situations are considered appropriate for conduction of telephone communications. For example, one can easily answer a call while driving.

Although convenient, considerable risk is inherent in such practice, since, under normal circumstances, users tend to answer a call immediately, with little concern for their environment. The distraction of receiving a phone call can dramatically impair reaction time, general situational awareness, and attention to detail. Statistically, the likelihood of experiencing a traffic accident is increased as much as four times if the phone is in use.

Technology can, accordingly, help to alleviate some of the hazards described.

### BRIEF DESCRIPTION OF THE DRAWINGS

FIG. 1 is a schematic structural diagram of one embodiment of a communication device as disclosed.

FIG. 2 is a flowchart of one embodiment of a method for limiting data transition in a communication device as disclosed.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

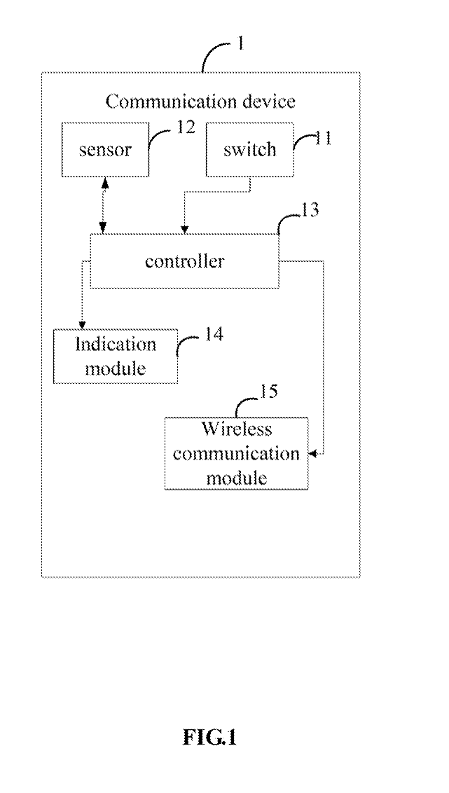

FIG. 1 is a schematic structural diagram of one embodiment of a communication device 1 as disclosed. The communication device 1 includes a switch 11, a sensor 12, a controller 13, an indication module 14 and a wireless communication module 15. The switch 11 initiates the communication device 1 into a safety mode, which means that one or more communication functions of the communication device 1 are disabled to protect safety of a user during driving a vehicle. When the communication device 1 receives an incoming call, the sensor 12 detects velocity of the communication device 1. In one exemplary embodiment, the velocity of the communication device 1 is an instant velocity of the vehicle. However, alternatively, the velocity can be an average velocity of the vehicle calculated during a definable period so that the sensor 12 detects the velocity complying with the definable period but not real time. The sensor 12 can be a GPS (Global Positioning System) sensor, an A-GPS (Assisted GPS) system or a combination of both. The sensor 12 also is capable of providing location of the communication device. The location can be coordinates of the communication device complying with World Geodetic Standard 1984.

The controller 13 receives a threshold value and stores the threshold value in the communication device 1. The threshold value, indicating a maximum allowable speed of the vehicle under the safety mode, is adjustable and defined by the user. In one exemplary embodiment, the threshold value can be predefined as the legal speed limit of the vehicle

The controller 13 compares the threshold value with the velocity of the communication device 1 when an incoming call is received by the communication device 1. Communication is initiated between the user of the communication device 1 and a caller when the incoming call is answered by the wireless communication module 16. In one exemplary embodiment, the communication between the communication device 1 and a terminal, such as another cell phone or telephone, is connected through at least one GSM/WCDMA cellular base station. When the measured velocity exceeds the threshold value, the controller directs the indication module 14 to issue notification on an output interface, such as a display or speaker. In one exemplary embodiment, notification can be issued by a specific tone or vibration of the communication device 1.

When the notification is issued but communication continues, after a buffer time, the controller 13 terminates the connection irrespective of the wishes of the user.

In one exemplary embodiment, when the connection between the communication device 1 and the terminal is terminated, the controller 13 notifies the caller that the user of the communication device 1 is not available to answer incoming calls through the at least one GSM/WCDMA cellular base station.

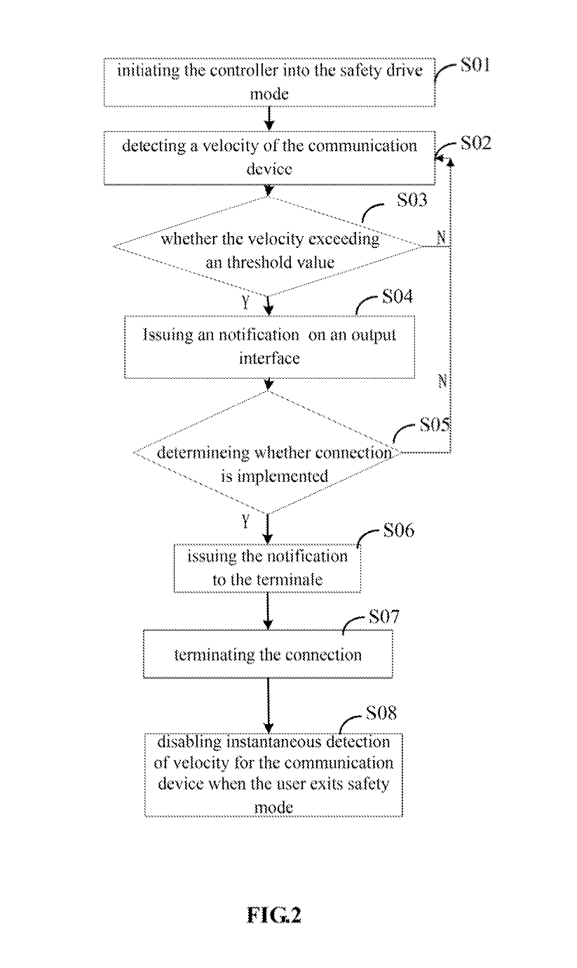

FIG. 2 is a flowchart of one embodiment of a method for limiting data transition in a communication device as disclosed 0000. Depending on the embodiment, additional blocks in the flow of FIG. 2 may be added, others removed, and the ordering of the blocks may be changed.

In block S01, the controller 13 is initiated to cause the communication device to enter into safety mode.

In block S02, the sensor detects a velocity of the communication device when an incoming call is received by the communication device 1. The measured velocity can be an instant velocity or an average velocity of the vehicle.

In block S03, the controller determines whether the velocity exceeds a threshold value.

In block S04, the indication module issues notification through an output interface, such as a display or a speaker of the communication device 1, that the currently measured velocity exceeds the set threshold.

In block S05, the controller determines whether connection between the communication device and at least one cellular phone is implemented.

In block S06, the controller issues notification to the at least one cellular phone through at least one cellular base station that the connection will be terminated due to the current excessive velocity.

In block S07, the controller terminates connection between the communication device and the at least one cellular phone.

In block S08, the controller disables instantaneous detection of velocity for the communication device when the user exits safety mode.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A communication device, comprising:
a sensor that detects a velocity of the communication device when an incoming call of the communication device is received and the communication device is in a safety mode;
a wireless communication module that initiates a communication with at least one terminal when the incoming call is answered; and
a controller that terminates the communication when the velocity exceeds a preset threshold value after a buffer time.

2. The communication device of claim 1, further comprising an indication module that issues a notification when the velocity exceeds the threshold value and the buffer time is initiated.

3. The communication device of claim 1, wherein the communication device issues a notification to the at least one terminal through at least one cellular base station, the notification indicating that the communication device is in the safety mode.

4. The communication device of claim 2, wherein the velocity is an instant velocity or an average velocity of the communication device when the communication device is in the safety mode.

5. The communication device of claim 2, wherein the sensor is a GPS/AGPS sensor.

6. The communication device of claim 1, wherein the at least one terminal is a GSM/WCDMA cellular phone.

7. A communication method, comprising:
detecting a velocity of a communication device that is in a safety mode when an incoming call of the communication device is received;
determining whether the velocity exceeds a preset threshold value once the incoming call is received; and
terminating a communication between the communication device and at least one terminal after a buffer time when the velocity exceeds the threshold value.

8. The communication method of claim 7, further comprising issuing a notification on an output interface of the communication device when the velocity exceeds the threshold value, wherein the buffer time is initiated after the notification is issued.

9. The communication method of claim 8, further comprising issuing the notification to the at least one terminal through at least one cellular base station that the communication device is in the safety mode.

10. The communication method of claim 7, wherein the at least one terminal is a GSM/WCDMA cellular phone.

11. The communication method of claim 7, wherein the velocity is instant velocity or average velocity of the communication device when the communication device is in the safety mode.

12. The communication method of claim 11, further comprising disabling detection of velocity of the communication device when the incoming call is terminated.
